(19) United States
(12) Patent Application Publication
(10) Pub. No.: US 2010/0171421 A1
(43) Pub. Date: Jul. 8, 2010

(54) HIGH-PRESSURE DISCHARGE LAMP

(75) Inventors: Atsuji NAKAGAWA, HIMEJI-SHI (JP); Toshitaka FUJII, HIMEJI-SHI (JP)

Correspondence Address: LUCAS & MERCANTI, LLP, 475 PARK AVENUE SOUTH, 15TH FLOOR, NEW YORK, NY, 10016, US

(73) Assignee: PHOENIX ELECTRIC CO., LTD., Himeji-shi (JP)

(21) Appl. No.: 12/652,799

(22) Filed: Jan. 6, 2010

(30) Foreign Application Priority Data
Jan. 7, 2009 (JP) 2009-001508

(51) Int. Cl. H01J 61/36

(52) U.S. Cl. 313/623

(57) ABSTRACT

The high-pressure discharge lamp includes: an arc tube; sealing portions which respectively have preseal glasses embedded therein, and at least one of which has an inert gas enclosing space which is arranged so as to be in contact with an outer surface of a corresponding the one preseal glass; a pair of feeders including a pair of electrodes, external lead rods, and metal foils, respectively; an external conductor which is arranged on an outer surface of the one sealing portion so as to be corresponded to the inert gas enclosed space, and connected to the external lead rod from the other sealing portion; and an internal conductor which is arranged in the inert gas enclosing space in the one sealing portion, and which has an electric potential identical to that of one feeder corresponding to the one sealing portion around which the external conductor is arranged.

### BACKGROUND OF THE INVENTION

### Field of the Invention

The present invention relates to a high-pressure discharge lamp used for a projector or the like.

A high-pressure discharge lamp, which is used as a light source of a projector or the like, includes an arc tube having mercury enclosed in its internal space, and sealing portions which extend from both ends of the arc tube and seal the internal space of the arc tube. The larger amount of mercury is enclosed and evaporated in the arc tube when the high-pressure discharge lamp is turned on, the larger amount of light is emitted therefrom. Accordingly, for an attempt to cause the high-pressure discharge lamp to emit the largest possible amount of light, the amount of mercury enclosed inside the arc tube has been increased gradually.

To start the high-pressure discharge lamp as above and to cause the light to emit continuously, high starting voltage is applied to a pair of electrodes to cause dielectric breakdown between the electrodes. The dielectric breakdown generates an arc, which evaporates and excites mercury enclosed in the arc tube. As described above, in the case where an amount of the mercury enclosed in the arc tube is increased, when a high-pressure discharge lamp emitting light is turned off, as the high-pressure discharge lamp is cooling down, fine particles of the mercury cools down and aggregates on the surface of the electrode. The aggregated fine particles of the mercury hinder arc generation at the time of starting (including “restarting”). As a result, higher voltage needs to be applied between the electrodes at the time of starting. In other words, starting performance of the high-pressure discharge lamp deteriorates.

Thus, a technology of improving the starting performance of the high-pressure discharge lamp, which is capable of reducing starting voltage, is developed. For example, a high-pressure discharge lamp 1 disclosed in Patent Document 1 (Japanese National Phase PCT Laid-Open Publication No. 2003-526182) has a sealed chamber 2 which includes a pair of sealing portions 3a and 3b, and metal foils 4a and 4b, as shown in FIG. 5. Between an inner surface of each sealing portion and each metal foil, an inert gas enclosing space 5 enclosing therein inert gas (Argon (Ar)) or mercury is formed. In addition, one end of a conductor 6 is wound around an outer surface of the sealing portion 3a, and the conductor 6 extends so as to be connected to an external lead rod 7b included in the other sealing portion 3b. Incidentally, an external lead rod included in the sealing portion 3a is represented by reference characters 7a.

At the time of starting, when voltage lower than normal dielectric breakdown voltage between electrodes is applied between the metal foil 4a and the conductor 6 in the sealing portion 3a, discharge is initiated between the metal foil 4 and the conductor 6, whereby ultraviolet rays are emitted. The ultraviolet rays irradiate a surface of a cathode electrode 8, and electrons are emitted therefrom, and thus the dielectric breakdown between the electrodes 8 is initiated easily. As a result, it is possible to reduce the starting voltage of the high-pressure discharge lamp 1.

The thinner the glass thickness T of the sealing portion 3a is, the stronger capacitive coupling between the metal foil 4a and conductor 6 is, and consequently, even if low voltage is applied at the time of starting, discharge is initiated between the metal foil 4 and the conductor 6, and ultraviolet rays can be discharged easily. As a result, the starting voltage between the electrodes 8 is reduced.

The high-pressure discharge lamp 1 disclosed in Patent Document 1 is capable of reducing the starting voltage to some extent. However, when the amount of the mercury enclosed in the arc tube 9 is increased, pressure capacity of the high-pressure discharge lamp 1 needs to be increased so that the high-pressure discharge lamp 1 is capable of resisting high pressure caused inside the arc tube 9 by mercury evaporation at the time of starting. In that case, a thick glass tube is required as the sealed chamber. Accordingly, the glass thickness T of a portion of the inert gas enclosing space 5, around which the conductor 6 is wound in the sealing portion 3a, is increased inevitably, and consequently, the capacitive coupling between the metal foil 4a and the conductor 6 is reduced. As a result, the discharge between the metal foil 4a and the conductor 6 and the consequent emission of ultraviolet rays cannot be caused by applying low voltage, and consequently, it is impossible to meet demands for reducing the starting voltage between the electrodes 8 by using the inert gas enclosing space 5 and the conductor 6.

### SUMMARY OF THE INVENTION

A main subject of the present invention is to provide a high-pressure discharge lamp which is capable of increasing capacitive coupling between the metal foil and the conductive material so as to reduce voltage necessary to initiate discharge between the metal foil and the conductor, while maintaining pressure capacity of the arc tube, thereby further reducing the starting voltage between the electrodes.

A first aspect in accordance with the present invention provides a high-pressure discharge lamp 10 that includes:

(1a) an arc tube 26 including thereinside a light emitting space having a light emitting material enclosed therein;
(1b) a pair of sealing portions 28a and 28b which extend from both ends of the arc tube 26, and which respectively have preseal glasses 38a and 38b embedded therein in an integrated manner, and at least one sealing portion 28a includes an inert gas enclosing space 46a which is arranged so as to be in contact with an outer surface of a corresponding one preseal glass 38a and so as to be separated from the light emitting space of the arc tube 26;
(1c) a pair of feeders K1 and K2 respectively having a pair of electrodes 34a and 34b which protrude outward from the preseal glasses 38a and 38b and which each have one end facing each other in the light emitting space; external lead rods 36a and 36b each having one end protruding outward from the sealing portions 28a and 28b; and metal foils 32a and 32b which are embedded in the preseal glasses 38a and 38b and which connect the electrodes 34a and 34b with the external lead rods 36a and 36b;
(1f) an external conductor 16 which is arranged on an outer circumference of the one sealing portion 28a so as to be corresponded to a position of the inert gas enclosed space 46a, and which is connected to one external lead rod 36b extending from the other sealing portion 28b; and
(1g) an internal conductor 15 which is arranged in the inert gas enclosing space 46a in the one sealing portion 28a, and which has an electric potential identical to that of one feeder K1 corresponding to the one sealing portion 28a around which the external conductor 16 is arranged.

According to the high-pressure discharge lamp 10 of the present invention, the sealing portions 28a and 28b respectively have the preseal glasses 38a and 38b embedded therein in an integrated manner, and the inert gas enclosing spaces 46a and 46b each having inert gas enclosed therein are arranged in contact with the outer surface of the preseal glasses 38a and 38b, in a manner to be separated from the light emitting space of the arc tube 26. Since the external conductor 16 is arranged to one of the sealing portions, the inert gas enclosing space may be arranged in only one of the sealing portions.

In this manner, since the preseal glass 38a is embedded in the sealing portion 28a in an integrated manner, a thickness t2 at a position of the inert gas enclosing space 46a is thinner than a thickness t1 of the arc tube 26. Accordingly, it is possible to increase capacitive coupling and to reduce starting voltage while maintaining the pressure capacity.

The internal conductor 15 may be composed of a metal foil arranged along an outer surface of the preseal glass 38a; or a conductive film arranged integrally with the outer surface 38a4 and an end surface 38a3; or a preseal glass penetrating portion Kt extending from the one metal foil 32a. One end of the internal conductor 15 may be arranged in the inert gas enclosing space 46a, and the other end of the internal conductor 15 may be connected to the feeder K1 of the sealing portion 28a.

The “metal foil” and the “conductive film” are used as the internal conductor 15, and thus it is possible to exert the same effect (i.e., securing airtightness) as the “metal foil” of the feeder K1 embedded in the preseal glass 38a. In addition, in the case where the “metal foil” is used as the internal conductor 15, while being connected (welded) with the external lead rod 36a, or where the “conductive film” is arranged integrally with the preseal glass 38a, when the high-pressure discharge lamp 10 is assembled, it is not necessary to hold the preseal glass 38a and the internal conductor 15 individually so as to be inserted into and fused with the sealing portion 28a. Instead, in this case, only the preseal glass 38a needs to be held and fused with the sealing portion 28a, and thus manufacturing efficiency of the high-pressure discharge lamp 10 can be improved.

When the preseal glass penetrating portion Kt extending from the metal foil 32a is used as the internal conductor 15, nothing is interposed between the outer surface of the preseal glass 38a and the inner surface of the sealing portion 28a unlike the case of the “metal foil” and the “conductive film”. Thus, the outer surface of the preseal glass 38a and the inner surface of the sealing portion 28a are fused in an integrated manner, and accordingly, not only the manufacturing efficiency, but also the airtightness of the inert gas enclosing space 46a can be further improved.

According to the present invention, by decreasing a glass thickness between an external conductor and an internal conductor while maintaining the pressure capacity of the arc tube, it is possible to increase a degree of capacitive coupling between the conductive materials, and also possible to easily cause discharge between the external conductor and the internal conductor. Accordingly, the starting voltage necessary between the electrodes can be further reduced.

### BRIEF DESCRIPTION OF THE DRAWINGS

FIG. 1 is a diagram showing a high-pressure discharge lamp according to a first embodiment of the present invention and a lighting system using the same;

FIG. 2 is a diagram showing procedures for manufacturing the high-pressure discharge lamp according to the first embodiment;

FIG. 3 is diagram showing a second embodiment of the present invention;

FIG. 4 is diagram showing another embodiment of the present invention; and

FIG. 5 is a diagram showing a high-pressure discharge lamp according to a conventional art.

### DESCRIPTION OF THE PREFERRED EMBODIMENTS

### First Embodiment

The high-pressure discharge lamp 10A according to the present invention includes a sealed chamber 12, a pair of mounts 14a and 14b which are embedded inside a pair of sealing portions 28a and 28b of the sealed chamber 12, an internal conductor 15, and an external conductor 16. A lighting system 24 is composed of the high-pressure discharge lamp 10A, a DC power supply 18 (or an AC power supply), a ballast 20, and a high frequency starting circuit 22.

The sealed chamber 12 includes a spherical-shaped arc tube 26 which has an internal space, and the pair of sealing portions 28a and 28b extending from both sides of the arc tube 26, respectively. The sealed chamber 12 is formed of silica glass which is insusceptible to thermal expansion and thermal contraction. The internal space of the arc tube 26 is filled with appropriate gas or filling materials (such as Argon or other appropriate gas, or mercury or the like). In the internal space, a pair of electrodes 34a and 34b are arranged so as to face each other. The arc tube 26 is formed to have a thickness T1 that is capable of resisting an increase in internal pressure within itself caused by mercury vapor at the time of starting.

The mounts 14a and 14b are embedded inside the sealing portions 28a and 28b. Feeders K1 and K2 are respectively composed of metal foils 32a and 32b, electrodes 34a and 34b, and external lead rods 36a and 36b. The feeders K1 and K2 are respectively arranged penetrating through preseal glasses 38a and 38b which respectively constitute the mounts 14a and 14b.

In addition, the electrodes 34a and 34b, which constitute tip ends of the feeders K1 and K2, respectively, are arranged in the internal space of the arc tube 26 so as to face each other. The preseal glasses 38a and 38b, and sealing portion constituting glass layers 28a1 and 28b1 surrounding the same are fused to each other integrally with base portions 28a2, 28b2 and end portions 28a3, 28b3 of the sealing portion 28a.

In addition, inert gas enclosing spaces 46a and 46b having an argon gas enclosed therein are arranged in the fused areas so as to come in contact with the outer surfaces of the preseal glasses 38a and 38b and so as to be separated from a light emitting space of the arc tube 26, respectively. In this description, the inert gas enclosing spaces 46a and 46b are arranged in both of the sealing portions 28a and 28b, respectively, as an example. However, only one inert gas enclosing space may be arranged in one of the sealing portions that has the external conductor 16 fixed thereto.

A thickness t2 of the sealing portion constituting glass layers 28a1 and 28b1 which are in contact with the inert gas enclosing spaces 46a and 46b is thinner than the thickness t1 of the arc tube 26 since a high internal pressure of the arc tube 26 at the time of starting is not directly applied thereto. The high internal pressure of the arc tube 26 is applied, at the time of starting, to the base portions 28a2 and 28b2 of the sealing portions 28a and 28b. Thus, in order for the base portions 28a2 and 28b2 to have a sufficient thickness, the base portions 28a2 and 28b2 are formed to have the same outer diameter as the sealing portions 28a and 28b while the preseal glasses 38a and 38b are embedded and welded in an integrated manner. In the present embodiment, tip ends of the embedded preseal glasses 38a and 38b which are welded in an integrated manner are truncated cone shaped, and the thickness of a portion between each tip end and an inner surface of the arc tube 26 is approximately the same as the thickness t1 of the arc tube 26.

As described above, majority portions of the mounts 14a and 14b are embedded in the sealing portions 28a and 28b. The mounts 14a and 14b are composed of: metal foils 32a and 32b made of molybdenum; tungsten electrodes 34a and 34b which each has a first end arranged in the internal space of the arc tube 26 and has a second end fixed to a first end of each of the metal foils 32a and 32b; external lead rods 36a and 36b which are each fixed to a second end of each of the metal foils 32a and 32b and which extend outward from the sealing portions 28a and 28b; and the preseal glasses 38a and 38b which embed thereinside the metal foils 32a and 32b, metal foil side end portions of the electrodes 34a and 34b, and metal foil side end portions of the external lead rods 36a and 36b. The metal foil 32a (32b), the electrode 34a (34b), and the external lead rod 36a (28b) are hereinafter collectively referred to as the feeder K1 (K2).

Further, the ends of the electrodes 34a, 34b, the ends being arranged in the arc tube 26, have an approximately identical shape in the case of an AC-powered high-pressure discharge lamp 10. However, the anode is formed larger than the cathode in the case of a DC-powered high-pressure discharge lamp 10. The above-described features can be applied to a second embodiment and thereafter.

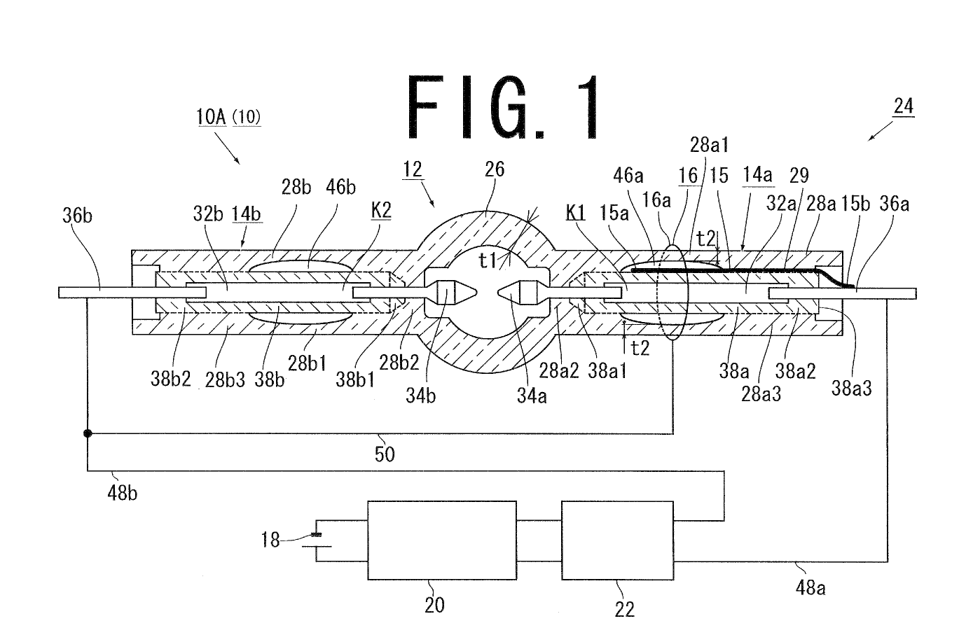

The internal conductor 15 shown in FIG. 1 is a metal foil having one end 15a disposed in the inert gas enclosed space 46a in the sealing portion 28a. The internal conductor 15 extends along the outer surface of the preseal glass 38a, and penetrates through an air-tight contact portion 29 between the sealing portion constituting glass layer 28a1 of the sealing portion 28a and the outer surface of the preseal glass 38a, and reaches the outside of the sealing portion 28a. The other end 15b of the internal conductor 15 is electrically connected to the external lead rod 36a by spot welding. The electric potential of the internal conductor 15 is the same as the feeder K1 including the external lead rod 36a. As another embodiment, the internal conductor 15 may be a conductive film which extends integrally with the outer surface and a surface 38a3 of the preseal glass 38a, or a preseal glass penetrating portion Kt which penetrates through the preseal glass 38a (the embodiments of the “conductive film” and the “preseal glass penetrating portion Kt” being described later).

The external conductor 16 is a metal wire whose one end is ring shaped and is wound around the outer surface of one of the sealing portions 28a so as to correspond to the position of the inert gas enclosing space 46a. The other end of the external conductor 16 is a wire 50 for an external conductor, the wire extending from the ring portion 16a, and fixed the external lead rod 36b extending from the other sealing portion 28b. The external conductor 16 need not be ring-shaped, but may be planar-shaped or block-shaped so as to be arranged facing the internal conductor 15. When the external conductor 16 is wound around and fixed to the outer surface of the sealing portion 28a, the external conductor 16 is unlikely to be deviated from the outer surface of the sealing portion 28a. Although not shown in the diagram, in order to further improve the starting performance of the high-pressure discharge lamp 10, a trigger wire (a wire arranged outside the arc tube and used by causing discharge between the trigger wire and the electrodes at the time of starting the high-pressure discharge lamp) and the external conductor 16 may be formed of a common metal wire.

The ballast 20 is a circuit which receives voltage from a DC power supply 18, and stably applies a constant amount of power, which is necessary for the high-pressure discharge lamp 10A to emit light, between the pair of electrodes 34a and 34b of the high-pressure discharge lamp 10A, regardless of fluctuations and temporal changes in the voltage supplied to the high-pressure discharge lamp 10A. Further, the ballast 20 is electrically connected, to the external lead rod 36a which is included in the feeder K1 on which external conductor 16 is arranged, and also connected to the external lead rod 36b which is included in the feeder K2, through wires 48a and 48b, respectively, via a high frequency starting circuit 22.

The high frequency starting circuit 22 is a circuit which raises frequency of the voltage received from the ballast 20 and supplies the voltage to the high-pressure discharge lamp 10A at the time of starting the high-pressure discharge lamp 10A, such that the dielectric breakdown is easily initiated between the electrodes 34a and 34b, and between the internal conductor 15 and the external conductor 16.

Capacitors have a feature of allowing higher frequency voltage to pass therethrough, and a kind of capacitor is established between the internal conductor 15 and the external conductor 16 due to electrostatic capacitive coupling. Thus, when the frequency of the voltage supplied at the time of starting the high-pressure discharge lamp 10A is high, the discharge (dielectric breakdown) between the electrodes 34a and 34b, and between the internal conductor 15 and the external conductor 16 can be accelerated. Excellent lighting performance of the present invention using this feature is described later.

(Procedure for Manufacturing the High-Pressure Discharge Lamp)

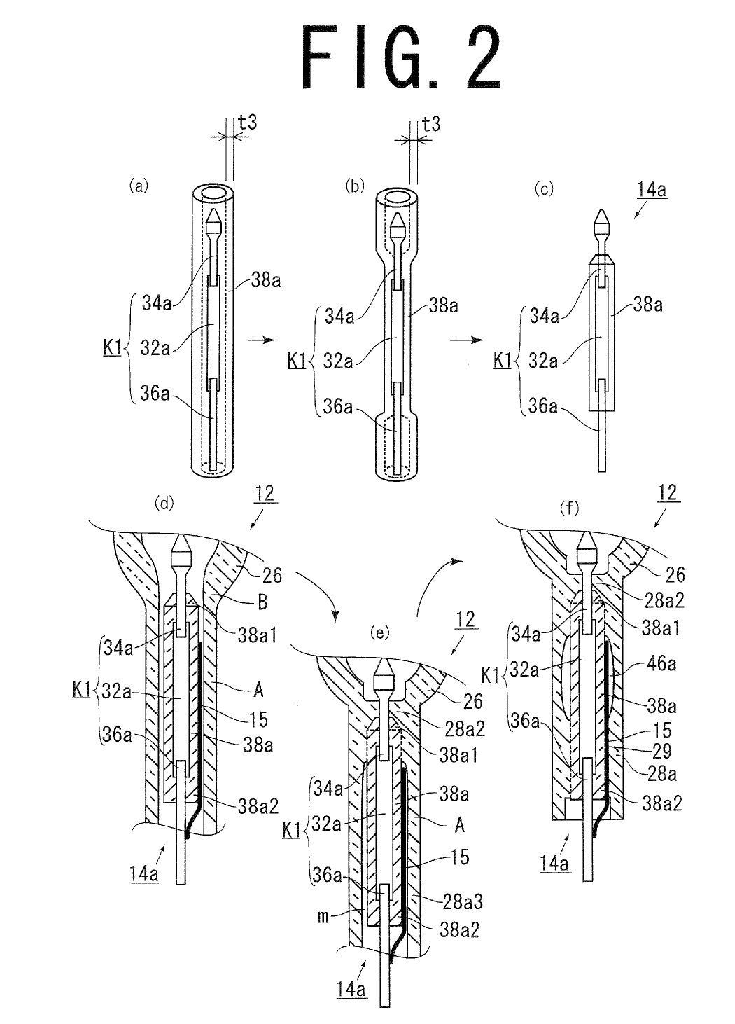

An exemplary procedure for manufacturing the high-pressure discharge lamp 10A according to the present embodiment is briefly described with reference to FIG. 2. [Process (a)] The second end of the electrode 34a is spot-welded to the first end of the metal foil 32a, and a first end of the external lead rod 36a is spot-welded to the second end of the metal foil 32a, whereby the feeder K1 is formed. The feeder K1 is inserted inside the preseal glass 38a having a thickness t3 of 0.5-0.8 mm.

[Process (b)] The preseal glass 38a is heated at 2000° C. or more (since a softening point of silica glass is about 1650° C., the heating temperature is set to 2000° C. or more) so as to cause thermal contraction (heat shrinkage).

[Process (c)] The heated preseal glass 38a is cut at its predetermined position, whereby the mount 14a having a column-shaped preseal glass 38a is obtained. Although the thermal contraction rate is different between the preseal glass 38a and the metal foil 32a, when the metal foil 32a is embedded inside the preseal glass 38a, the mechanical strength of the preseal glass 38a is sufficiently lager than that of the metal foil 32a, and thus extension and contraction of the metal foil 32a caused by the thermal expansion is completely restricted, and thus the surface of the metal foil 32a and a contact surface of the preseal glass 38a are fused with each other completely airtightly. The above situation is similarly applied to the mount 14b.

[Process (d)] One end of the internal conductor 15, which is made of a strip shaped metal foil, is welded to the external lead rod 36a of the mount 14a, and is arranged along the preseal glass 38a. The mount 14a prepared as such is inserted, together with the internal conductor 15, to an internal space of a pre-fused glass tube A under an inert atmosphere composed of an argon gas. The glass tube A is to constitute the sealing portion 28a of the sealed chamber 12 after fusion (the diameter of the preseal glass 38 after thermal contraction is smaller than an inner diameter of the pre-fused glass tube A, i.e., a part of the sealing portion 28a). The mount 14a and the internal conductor 15 are positioned appropriately in the internal space of the pre-fused glass tube A, which is to constitute the sealing portion 28a.

[Process (e)] In this state, the inside of the sealed chamber 12 and a joint portion B between the arc tube 26 and the sealing portion 28a in the sealed chamber 12 are heated at 2000° C. or more for 10 to 12 seconds to be shrunk, whereby the internal space of the arc tube 26 and the internal space of the glass tube A, which constitutes the sealing portion 28a, are separated from each other having the base portions 28a2 formed therebetween. In this case, the electrode side tip end 38a1 of the preseal glass 38a is embedded inside the base portions 28a2 of the sealing portion 28a, and fused in an integral manner. As described above, the base portions 28a2 is formed to have a thickness so as to resist the high internal pressure of the arc tube 26 at the time of starting. At this stage, only the base portions 28a2 of the sealing portion 28a is sealed, and thus an end of the glass tube A (a lower side in the drawing) and a lower side of the preseal glass 38a in the drawing are separated having a certain gap m therebetween and are open to the outside. In addition to the above-described shrink sealing method, a pinch sealing method for pinching heated sealing portion 28a may be applied.

[Process (f)] As described above, since shrinking is performed under the inert atmosphere composed of an argon gas, the gap m formed between the inner surface of the glass tube A constituting the sealing portion 28a and the outer surface of the preseal glass 38a is filled with an argon gas. In this state, a portion 28a3, which is a portion of the glass tube A and corresponds to the outer surface of an external lead rod side end portion 38a2 of the preseal glass 38a, is heated externally and shrunk at 2000° C. or more for 10 to 12 seconds, for example (or may be pinch sealed). The outer surface of the preseal glass 38a and the inner surface of the glass tube A, i.e., the sealing portion 28a, are, thereby, fused to each other (a portion, where the internal conductor 15 made of strip shaped metal foil is arranged, is fused while the internal conductor 15 is interposed therebetween), whereby an airtight space 46a, that is, “an inert gas enclosing space 46a”, having an argon gas sealed therein is formed between the welded portion 29 and the base portions 28a2. Accordingly, the preseal glass 38a is embedded in the sealing portion 28a in an integrated manner, and then, the sealing portion 28a is completed.

After the sealing portion 28a is completed, the internal space of the arc tube 26 is enclosed with the inert gas (Ar or other appropriate gas), mercury, and any other appropriate filler, and then the sealing portion 28b on the other side is manufactured in the same manner as described above with the use of the mount 14b without having the internal conductor 15. As to the mount 14b, the entire portion of the preseal glass 38b may be welded with the sealing portion 28b without forming the inert gas enclosing space 46a.

Finally, the ring portion 16a of the external conductor 16 is wound around the outer circumference of the sealing portion 28a, and the wire 50 for the external conductor extending from the ring portion 16a is connected to the external lead rod 36b, whereby manufacture of the high-pressure discharge lamp 10 is completed.

(Procedure for Starting the High-Pressure Discharge Lamp)

With reference to FIG. 1, when the high-pressure discharge lamp is started, high-frequency high voltage (which is lower than the starting voltage generated between the electrodes) is generated in the high frequency starting circuit 22, and the high voltage is applied between the electrodes 34a and 34b. At the same time, the high voltage is also applied, via the wire 50 for the external conductor, between the internal conductor 15 and the ring portion 16a of the external conductor 16 arranged in the sealing portion 28a. The thickness t2 of the sealing portion constituting glass layer 28a1 located between the ring portion 16a of the external conductor 16 and the internal conductor 15 is thin due to the presence of the preseal glass 38a. Accordingly, the electrostatic capacitive coupling therebetween is strong, and as a result, the dielectric breakdown is caused when voltage is applied between the internal conductor 15 and the external conductor 16, the voltage being lower than that causing the dielectric breakdown between the electrodes 34a and 34b, but being higher than that causing the dielectric breakdown of the argon gas in the inert gas enclosing space 46a. With the dielectric breakdown, the ultraviolet rays are emitted from the excited argon gas.

The ultraviolet rays pass through the sealing portion 28a of the sealed chamber 12 and reach the arc tube 26 instantaneously (optical fiber effect). With the electrodes 34a and 34b, electronic discharge from a surface of the electrode 34a (or 34b) is initiated. The initiation of the electronic discharge induces the dielectric breakdown between the electrodes 34a and 34b. That is, the dielectric breakdown between the electrodes 34 is initiated with considerably lower starting voltage compared to a case where the ultraviolet rays are not emitted.

According to the high-pressure discharge lamp 10A of the present embodiment, it is possible to reduce the glass thickness t2 of the sealing portion 28a, at which the inert gas enclosing space 46a is located and the external conductor 16 is arranged, while the pressure capacity is maintained as described above. In addition, it is possible to increase the degree of the capacitive coupling between the external conductor 16 and internal conductor 15, which are separated from each other, regardless of the pressure capacity. Therefore, the starting voltage required for initiating discharge between the electrodes 34a and 34b can be reduced.

### Second Embodiment

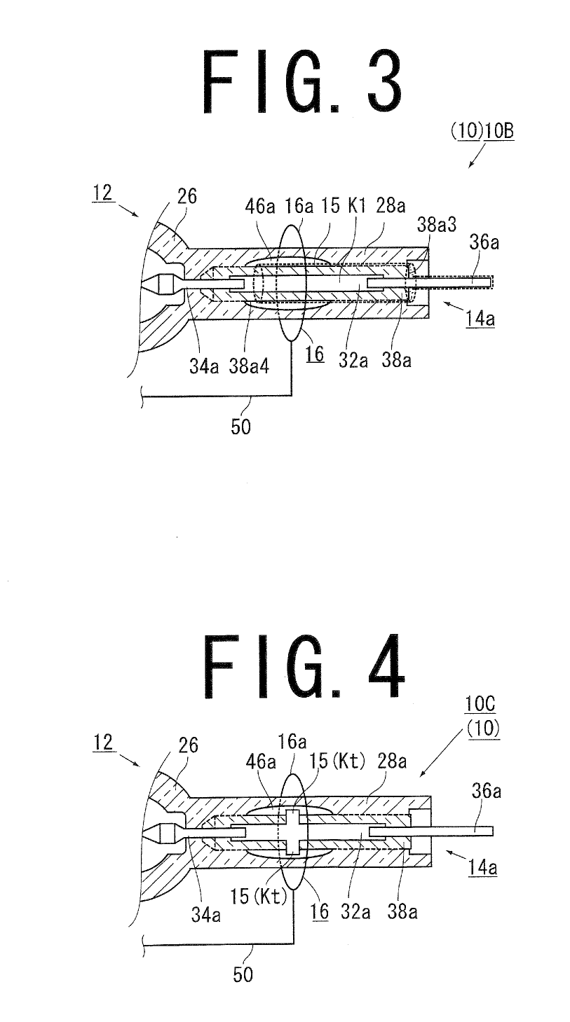

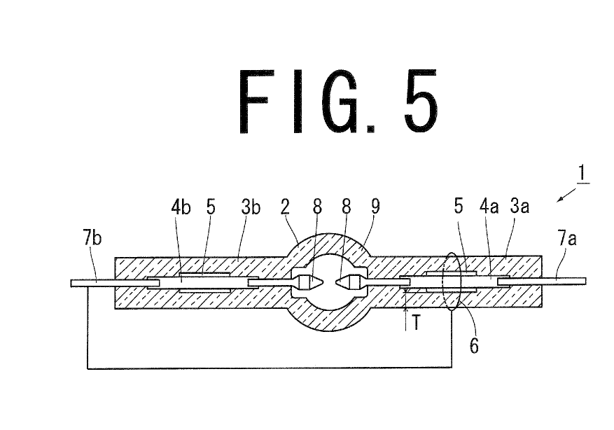

With reference to FIG. 3, a high-pressure discharge lamp 10B according to a second embodiment of the present invention is described. The second embodiment is different from the first embodiment in that the internal conductor 15 is composed of “a conductive film that is arranged integrally with the outer circumferential surface of the preseal glass 38a”. Hereinafter, only the internal conductor 15 is described, and description of the first embodiment is incorporated in the second embodiment in relation to configurations and effects of the remaining component parts.

In the present embodiment, the internal conductor 15 is a conductive film arranged integrally with an outer surface 38a4 (a part of which is arranged inside the inert gas enclosing space 46a) and the end surface 38a3 of the preseal glass 38a, and also with the external lead rod 36a. Specifically, about a half portion of the preseal glass 38a and the external lead rod 36a are immersed in (or coated with) silicotungstic acid, and undergo hydrogen reduction in a kiln, whereby the conductive film is obtained.

In this manner, when the conductive film is used as the internal conductor 15, it is possible to obtain the same effect as the above case where the “metal foil” is used. In addition, since the conductive film is configured integrally with the preseal glass 38a, when the high-pressure discharge lamp 10B is assembled, it is not necessary to hold the preseal glass 38a and the internal conductor 15 individually so as to be inserted inside and welded with the sealing portion 28a. Instead, in this case, only the preseal glass 38a needs to be held and welded with the sealing portion 28a, and thus manufacturing efficiency of the high-pressure discharge lamp 10B can be improved.

The configuration of the internal conductor 15 is not limited to the above configuration. As shown in FIG. 4, the sealing portion 28a may be configured such that a preseal glass penetrating portion Kt is arranged in a middle portion of the strip-shaped metal foil 32a that is included in the feeder K1 (in an embodiment shown in the diagram, two preseal glass penetrating portions Kt are arranged vertically above and below the metal foil 32a). The feeder is inserted in two short preseal glass tubes, which are not shown in the drawing, and are then heated and shrunk, such that a tip end of each of the preseal glass penetrating portions Kt penetrates through the welded preseal glass 38a, from the surface of the preseal glass 38a, the surface abutting against each of the two short preseal glass tubes, and that the tip end is arranged in the inert gas enclosing space 46a. In this case, the mount 14a and the internal conductor 15 can be arranged as one component part, and thus the manufacturing efficiency of the high-pressure discharge lamp 10C can be further improved.

Although the invention has been described in its preferred form with a certain degree of particularity, it is understood that the present disclosure of the preferred form has been changed in the details of construction and the combination and arrangement of parts may be resorted to without departing from the spirit and scope of the invention as hereinafter claimed.

The disclosure of Japanese Patent Application No 2009-001508 filed Jan. 7, 2009 including specification, drawings and claims is incorporated herein by reference in its entirety.

What is claimed is:

1. High-pressure discharge lamp comprising:
an arc tube including thereinside a light emitting space having a light emitting material enclosed therein;
a pair of sealing portions which extend from both ends of the arc tube, and which respectively have preseal glasses embedded therein in an integrated manner, and at least one sealing portion includes an inert gas enclosing space which is arranged so as to be in contact with an outer surface of a corresponding one preseal glass and so as to be separated from the light emitting space of the arc tube;
a pair of feeders respectively having a pair of electrodes which protrude outward from the preseal glasses and which each have one end facing each other in the light emitting space, external lead rods each having one end protruding outward from the sealing portions, and metal foils which are embedded in the preseal glasses and which connect the electrodes with the external lead rods;
an external conductor which is arranged on an outer circumference of the one sealing portion so as to be corresponded to a position of the inert gas enclosed space, and which is connected to one external lead rod extending from the other sealing portion; and
an internal conductor which is arranged in the inert gas enclosing space in the one sealing portion, and which has an electric potential identical to that of one feeder corresponding to the one sealing portion around which the external conductor is arranged.

2. The high-pressure discharge lamp according to claim 1, wherein the internal conductor is composed of a metal foil arranged along an outer surface of the one preseal glass.

3. The high-pressure discharge lamp according to claim 1, wherein the internal conductor is composed of a conductive film arranged integrally with the outer surface and an end surface of the one preseal glass.

4. The high-pressure discharge lamp according to claim 1, wherein the internal conductor is composed of a preseal glass penetrating portion extending from the one metal foil, and having one end arranged in the inert gas enclosed space and the other end connected to one feeder corresponding to the one sealing portion.

5. The high-pressure discharge lamp according to claim 1, wherein an argon gas is enclosed in the inert gas enclosing space.

6. The high-pressure discharge lamp according to claim 1, wherein each metal foil is formed of molybdenum.

7. The high-pressure discharge lamp according to claim 1, wherein each electrode is formed of tungsten.

8. The high-pressure discharge lamp according to claim 1, wherein the external conductor is wound around the outer surface of the one sealing portion and fixed thereto.

9. The high-pressure discharge lamp according to claim 1, wherein the external conductor has a ring shape.

10. The high-pressure discharge lamp according to claim 1, wherein the external conductor has a planer shape.

11. The high-pressure discharge lamp according to claim 1, wherein the external conductor has a block shape.

12. The high-pressure discharge lamp according to claim 1, further comprising
a trigger wire which is arranged outside of the arc tube and is used by causing discharge with the electrodes when the high-pressure discharge lamp is started,
wherein the external conductor and the trigger wire are formed of a common metal wire.
